(19) United States
(12) Patent Application Publication
(10) Pub. No.: US 2011/0084511 A1
(43) Pub. Date: Apr. 14, 2011

(54) AUTOMOTIVE FORWARD STORAGE BIN DISAPPEARING TRAY

(76) Inventors: Gregg S. Evans, Windsor (CA); Charles M. Christ, Holly, MI (US); James V. Gorman, Holly, MI (US); Steven E. Malecki, Clinton Township, MI (US); Mark A. Murray, Waterford, MI (US); Michael W. Zikewich, Lake Orion, MI (US)

(21) Appl. No.: 12/898,780

(22) Filed: Oct. 6, 2010

Related U.S. Application Data
(60) Provisional application No. 61/251,151, filed on Oct. 13, 2009.

(51) Int. Cl. B60R 7/06

(52) U.S. Cl. 296/37.12

(57) ABSTRACT

An automobile storage system is disclosed. The system includes a base, a pair of opposed side walls, and an end wall. The system further includes an adjustable divider tray with a first segment and a second segment. The first segment is pivotally connected to the end wall or one of the side walls along a first hinge axis, and the first segment is pivotally connected to the second segment along a second hinge axis. The hinge axes are parallel. The tray has a closed position in which the tray divides the interior into a first compartment and a second compartment, the first compartment is accessible, and the divider tray is disposed between the access opening and the second compartment. The tray is movable away from the closed position to an open position in which the interior of the system functions as a unitary compartment.

### CROSS-REFERENCE TO RELATED APPLICATIONS

This non-provisional application claims the benefit of U.S. Provisional Patent Application No. 61/251,151, filed Oct. 13, 2009, the entirety of which is hereby incorporated by reference.

### BACKGROUND OF THE INVENTION

a. Field of the Invention

This invention relates generally to automobile storage units, and, more particularly, to an automotive forward storage bin disappearing tray.

b. Background Art

Automobile manufacturers have implemented a variety of storage bins, consoles, and glove boxes for storing items in the passenger compartment. In today's electronic era, users often use the storage bins or glove boxes to store a variety of electronic devices, such as cell phones, portable music players, Bluetooth-enabled devices and other components that may electronically connect to an automobile via USB, power, signal, or other port. For a storage bin or glove box normally used to store a variety of other non-electronic items, the addition of wires and electronic devices can easily clutter the storage space. Such clutter can lead to frustration in a user's ability to access items in the storage space, and can damage the electronic or non-electronic items.

Accordingly, there is a need for a storage system that minimizes or eliminates one or more of the problems set forth above.

### BRIEF SUMMARY OF THE INVENTION

An automobile storage system is disclosed. In one embodiment, the system includes a base, a pair of opposed side walls extending from the base, and an end wall extending from the base. The base, the side walls, and the end wall cooperate to define an access opening configured to allow access to an interior of the system. The system further includes an adjustable divider tray with a first segment and a second segment. The first segment is pivotally connected to the end wall or one of the side walls along a first hinge axis. The first segment is pivotally connected to the second segment along a second hinge axis parallel to the first hinge axis.

The tray has a closed position in which the tray divides the interior into at least a first compartment and a second compartment. In the closed position, the first compartment is accessible via the access opening but the divider tray is disposed between the access opening and the second compartment. The tray is movable away from the closed position to an open position in which the interior functions as a unitary compartment. In an embodiment, the divider tray, in the open position, no longer divides the interior, thereby effectively re-joining the first and second compartments. Moreover, in an embodiment, the divider tray is substantially out of view (i.e., “disappearing” tray).

Additional features, advantages, and embodiments of the invention may be set forth or become apparent from consideration of the following detailed description, drawings, and claims. Moreover, it is to be understood that both the foregoing summary of the invention and following detailed description are exemplary and intended to provide further explanation without limiting the scope of the invention as claimed.

### BRIEF DESCRIPTION OF THE DRAWINGS

FIG. 1 is a perspective view of an automotive interior illustrating exemplary locations for a storage system according to the present invention.

FIG. 2 is a perspective view of a first storage system embodiment with a divider tray in a closed position.

FIG. 3 is a perspective view of the embodiment of FIG. 2 with the divider tray in an intermediate position between the closed position and an open position.

FIG. 4 is a perspective view of the embodiment of FIG. 2 with the divider tray in the open position.

FIG. 5 is a side cross-sectional view of the first storage system embodiment taken substantially along lines 5-5 in FIG. 2, with the tray in the closed position.

FIG. 6 is a side cross-sectional view of the first storage system embodiment taken substantially along lines 6-6 in FIG. 3, with the tray in the intermediate position.

FIG. 7 is a side cross-sectional view of the first storage system embodiment taken substantially along lines 7-7 in FIG. 4, with the tray in the open position.

FIG. 8 is an enlarged cross-sectional view of a portion substantially encircled in FIG. 5 showing a first hinge.

FIG. 9 is an enlarged cross-sectional view of a portion substantially encircled in FIG. 5 showing a second hinge.

FIG. 10 is an enlarged cross-sectional view of the first hinge encircled in FIG. 6.

FIG. 11 is an enlarged cross-sectional view of the second hinge encircled in FIG. 6.

FIG. 12 is a top cross-sectional view taken substantially along lines 12-12 in FIG. 5.

FIG. 13 is a top cross-sectional view taken substantially along lines 13-13 in FIG. 7.

FIG. 14 is a top cross-sectional view taken substantially along lines 14-14 in FIG. 7.

FIG. 15 is a perspective view of a second storage system embodiment with a divider tray in the closed position.

### DETAILED DESCRIPTION OF EMBODIMENTS OF THE INVENTION

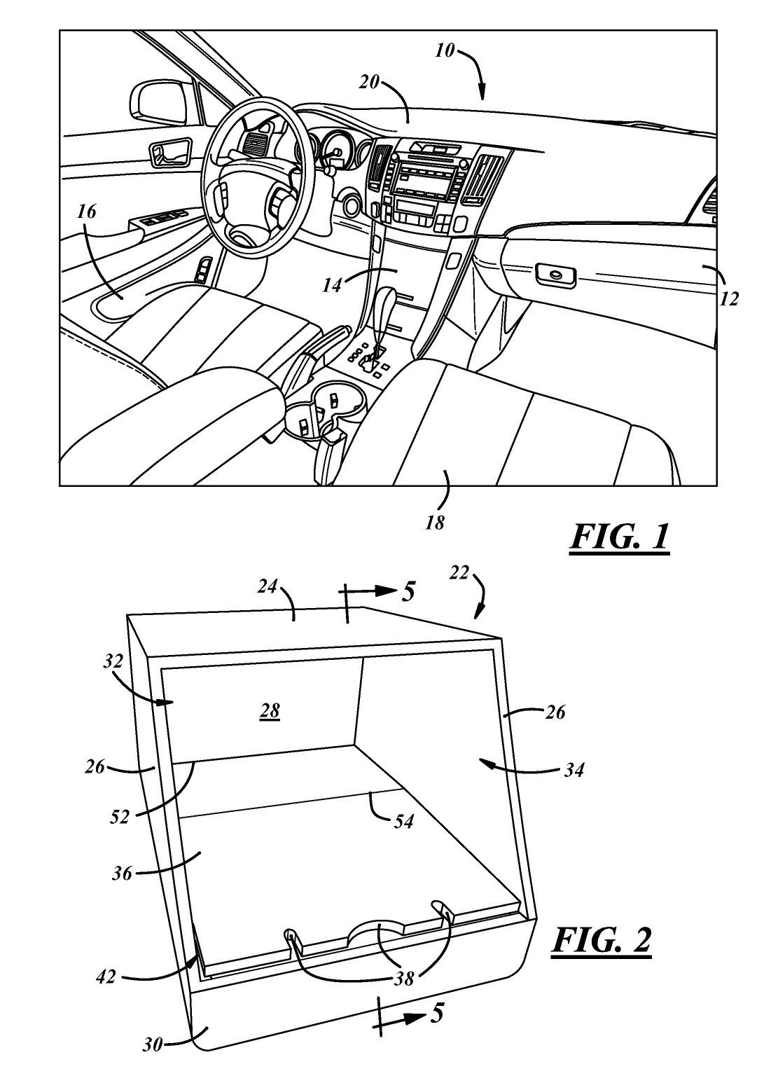

The present disclosure relates to an automobile storage system. Referring now to the drawings wherein like reference numerals designate corresponding parts throughout the several views, FIG. 1 shows some exemplary locations in an automobile interior 10 where an embodiment of the inventive storage system may be deployed. Embodiments may be deployed in traditional storage locations known in the art, such as a first location corresponding to a glove box 12, a second location corresponding to a forward storage bin 14, and a third location corresponding to a door compartment 16. It should be understood, however, that other locations may be identified and used. For example, less traditional locations for interior storage may also be used, such as a fourth location corresponding to an under seat 18 storage or a fifth location corresponding to another space in a dash assembly 20. In addition, various storage system embodiments may be accessed from the top, front, back, side, bottom, or any other point of access allowed by the configuration of the vehicle.

FIG. 2 is a perspective view of a first storage system embodiment, designated by reference numeral 22. Storage system 22 includes a top wall 24, a pair of opposed side walls 26, an end wall 28, and a base 30. Top wall 24, side walls 26, and base 30 cooperate to define an access opening 32. Access opening 32 is configured to allow access to an interior 42 of system 22. In another embodiment (not shown), top wall 24 may be omitted (e.g., another portion of the vehicle may form the top of system 22) wherein the outline of side walls 26, base 30, and end wall 28 cooperate to define access opening 32.

A first upper compartment 34 is visible through access opening 32 (and accessible for storage and retrieval of goods). Storage system 22 further includes an adjustable divider tray 36, which, when in the closed position (as shown), defines the “bottom” of upper compartment 34. Tray 36 may be configured to include one or more gaps 38 arranged to facilitate user manipulation of tray 36 (i.e., moving tray 36 between open and closed positions). Gaps 38 may also be configured for routing electronic cables from their origin in the lower compartment into upper compartment 34 to be made available for connection. Although gaps 38 are shown as wire and finger notches in the edge of tray 36, gaps 38 could be placed in any number, shape, or configuration on tray 36, or be designed into the geometry of system 22—such as gaps 38 between tray 36 and sidewalls 26—and still fall within the spirit and scope of the present invention. FIG. 2 also shows first and second hinges 52, 54, respectively. As described below, hinges 52, 54 facilitate movement of tray 36 to an open position.

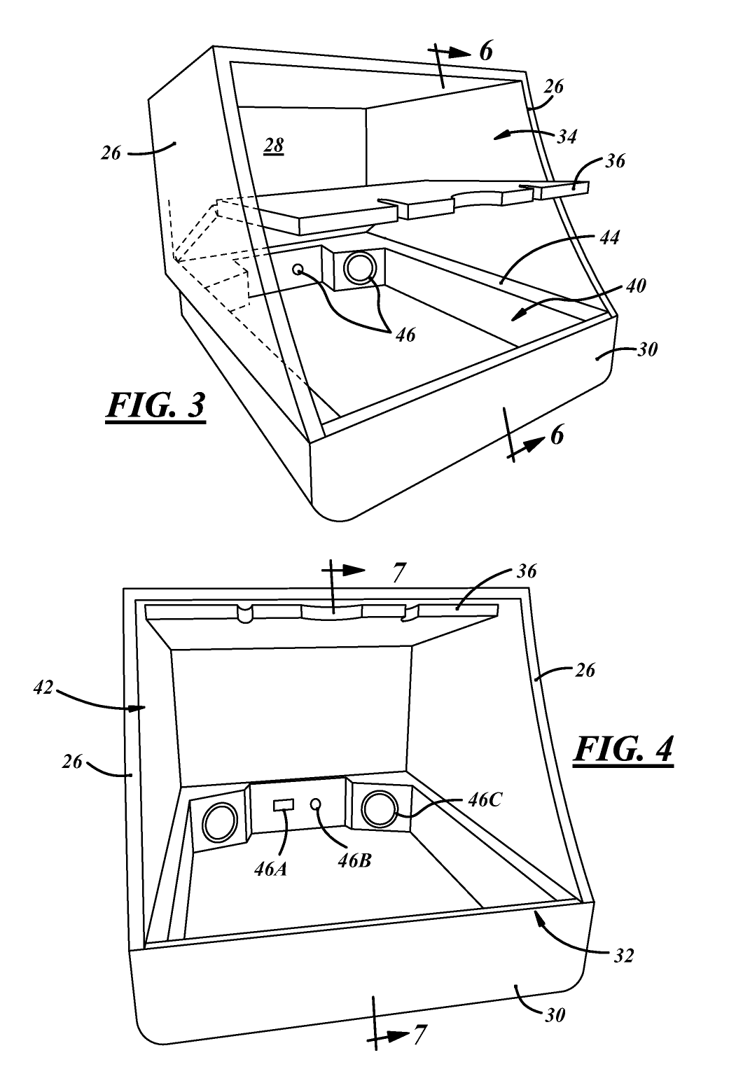

FIG. 3 is a perspective view of the embodiment of FIG. 2 with divider tray 36 in an intermediate position. In particular, tray 36 is configured to be moved from the closed position to the intermediate position shown, thereby revealing a second lower compartment 40. Together, upper compartment 34 and lower compartment 40 comprise system interior 42 (e.g., shown in FIG. 2), described above. Lower compartment 40 functions as a storage space and is defined in part by base 30, from which end wall 28 and side walls 26 extend. Base 30 may also include a lower retention surface 44 to support tray 36 when in the closed position. In this embodiment, lower compartment 40 is configured for storage and connection of electrical cables. Accordingly, electrical connection ports 46 may be disposed within lower compartment 40.

FIG. 4 is a further perspective view of system 22 showing tray 36 in an open position. With the tray in the open position, upper compartment 34 is substantially undivided from lower compartment 40, and system interior 42 may function as a unitary storage compartment. In other words, when in the open position, access opening 32 provides access to the entire interior 42, including upper and lower compartments 34, 40. Additionally, connection ports 46, in the lower compartment, are fully accessible through opening 32. Electrical connection ports 46 may be USB ports 46A, power outlets 46B, signal ports 46C, or any other electronic signal or power connection desired within vehicle interior 10. Although electrical connection ports 46 are shown generally within base 30, it should be understood that many variations would fall within the scope of the present invention.

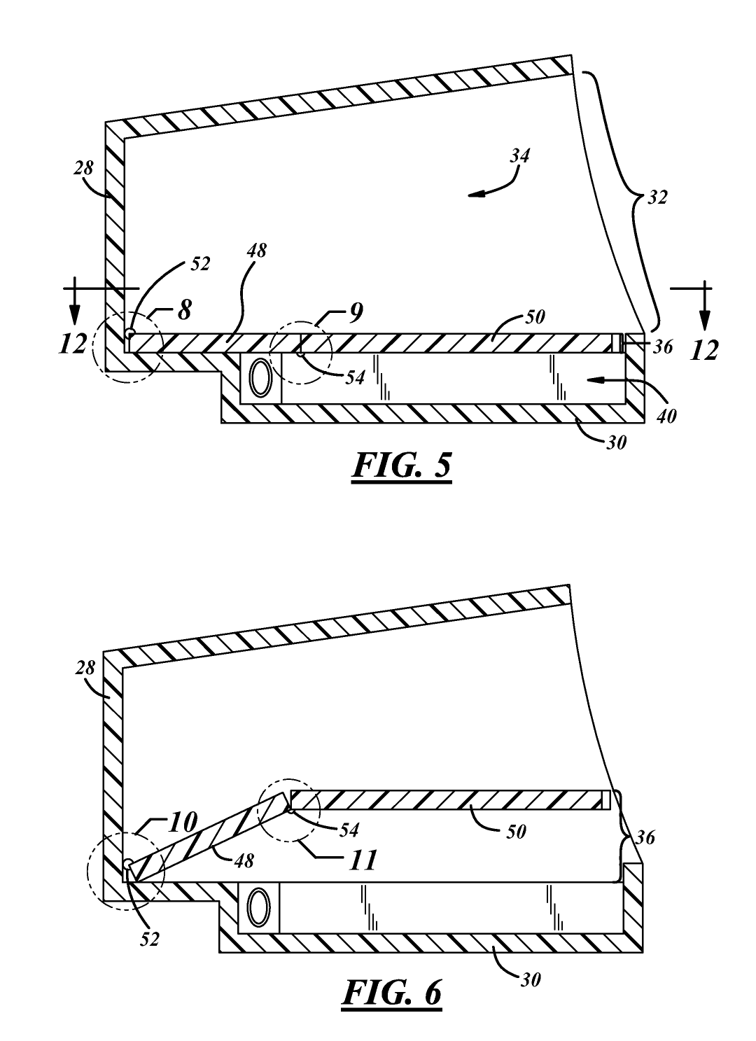

FIGS. 5-7 are cross-sectional views illustrating system 22 with tray 36 in closed, intermediate, and open positions, respectively. In the illustrated embodiment, tray 36 may be configured so that, in the open position, it does not interfere substantially with the access to or use of system interior 42 (i.e., is not “in the way”). In this regard, tray 36 may include a first segment 48 and a second segment 50. First segment 48 may be pivotally connected to end wall 28 using a first hinge 52 configured to allow first segment 48 to rotate about a corresponding first hinge axis. In addition, segment 48 may be further pivotally connected to second segment 50 using a second hinge 54 configured to allow second segment 50 to rotate about a corresponding second hinge axis. In the embodiment, the length of segment 48 (i.e., taken along an axis perpendicular to first hinge axis) may be roughly equal to the inside wall height of that portion of end wall 28 between top wall 32 and the connection location of first hinge 52 to end wall 28. Tailoring these dimensions to each other allows first segment 48 to fold up flat up against end wall 28 (i.e., flush up against end wall 28). Likewise, the length of second segment 50 should not exceed the inside wall depth of top wall 24. Through the foregoing placement of hinges 52, 54 and dimensional selection for first and second segments 48, 50, the divider tray 36 can effective “disappear” from view when moved to the open position.

Hinges 52, 54 allow tray segments 48, 50 to (i) rotate one relative to the other about corresponding, parallel hinge axes, as well as (ii) rotate relative to the end wall, so that the tray 36 is movable through interior 42 to selectively divide upper compartment 34 from lower compartment 40 (when in the closed position), or allow interior 34 to function as a unitary storage compartment (when in the open position). Hinges 52, 54 may comprises conventional hinge construction and materials known in the art, and in one embodiment, may comprise living hinges.

While tray 36 is pivotally connected to end wall 28 in the illustrated embodiment, it should be understood that tray 36, in alternative embodiments, may be connected to other available surfaces or structure of the system 22. For example, as shown in FIG. 15, tray 36 may be pivotally connected to one of side walls 26.

FIG. 5 is a cross-sectional view showing tray 36 in the closed position, disposed between access opening 32 and lower compartment 40. As a consequence of its positioning, tray 36 substantially blocks line-of-sight to the lower compartment as taken from the point of view of the access opening (i.e., the point from which a user would view the storage system interior). In this embodiment, upper compartment 34 remains accessible via access opening 32 even when tray 36 is in the closed position. Tray 36 may comprise substantially solid and/or opaque material; as a result, most or all of second compartment 48 may be visually obscured by tray 36 and base 30. Thus upper compartment 34 may remain visually as well as physically free of clutter with tray 36 in the closed position.

The walls of storage system 22, including divider tray 36, may comprise conventional materials known in the art. In certain embodiments, the walls (including tray 36) may comprise one or more of pressed-fiber board, polypropylene-based materials and polypropylene oxide (PPO) materials.

Referring to FIGS. 8-9, first hinge 52 pivotally connects first segment 48 to end wall 28. Hinge 52, as shown, may be arranged relative to end wall 28 so as to maintain said first segment 48 in a substantially perpendicular relationship with said end wall 28 when said tray is moved into said closed position, even in the absence of a support ledge 44. Second hinge 54 between said first and second tray segments 48, 50 is, in one embodiment, arranged relative to the two segments 48, 50 so as to maintain segments 48, 50 in a substantially co-planar relationship when the tray 36 is in the closed position. In sum, when tray 36 is in the closed position, first segment 48 may extend generally in a perpendicular direction relative to end wall 28, with second segment 50 being substantially coplanar with first segment 48.

FIG. 6 is a cross-sectional view showing tray 36 in an intermediate position as it is moved between the closed position and the open position.

Referring to FIGS. 10-11, first segment 48 rotates on hinge 52 about the first hinge axis relative to end wall 28, and second segment 50 rotates on second hinge 54 about the second hinge axis relative to first segment 48. In one embodiment, second hinge 54 is arranged so as to only allow second segment 50 to rotate in one direction relative to first segment 48. In one such embodiment, a user may move tray 36 away from the closed position as a unitary piece for quick access to lower compartment 40. An additional advantage of such an embodiment is that tray 36 can hold a reasonable cargo weight without requiring support from underneath tray 36 along the entire length of tray 36.

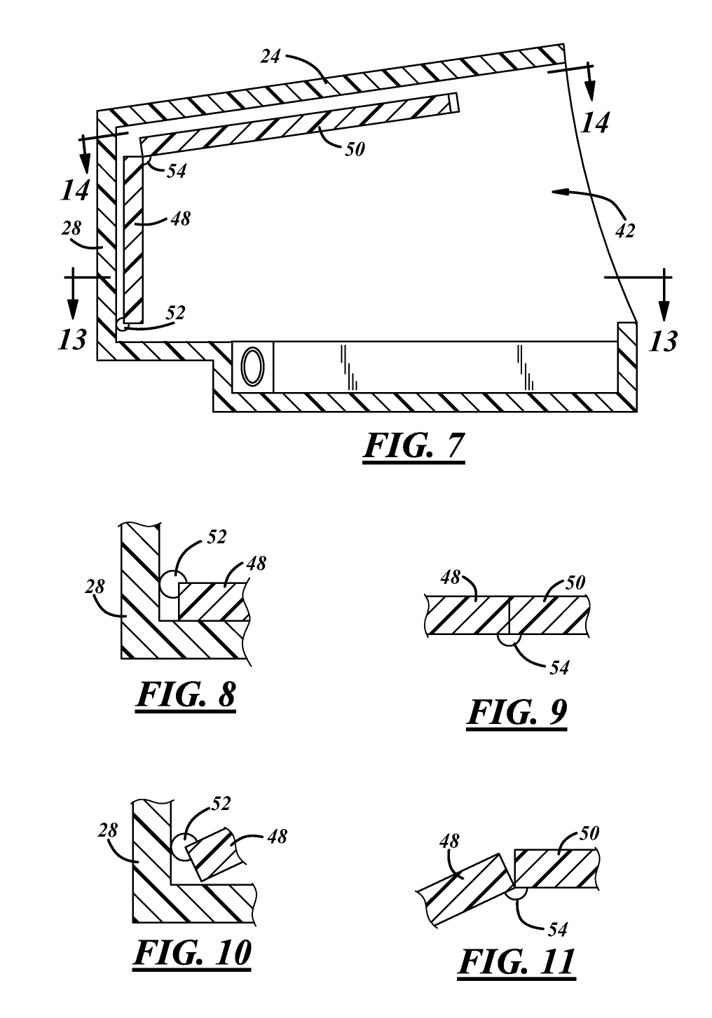

FIG. 7 shows the completion of the rotational movement from the closed position to the open position. First segment 48 is rotated to the limit of first hinge 52 and rests parallel to and flush against end wall 28. Second segment 50 is rotated on second hinge 54 as much as necessary for second segment 50 to rest substantially parallel to and flush against top wall 24. In the open position, upper compartment 34 and lower compartment 40 are no longer separated by divider tray 36, and system interior 42 may be used as a unitary storage compartment.

The foregoing embodiment of tray 36 offers many advantages. A user can easily place tray 36 in the open position to access interior 42 as a larger unitary storage compartment. Or a user can place tray 36 in the closed position, wherein tray 36 effectively conceals lower compartment 40—and the clutter it may contain—while still allowing cables to be routed between compartments. The configuration of tray 36 makes the transition from the open position to the closed position, and vice versa, quick and simple. Additionally, the configuration of tray 36 allows a user to quickly tilt tray 36 out of the closed position to access lower compartment 40.

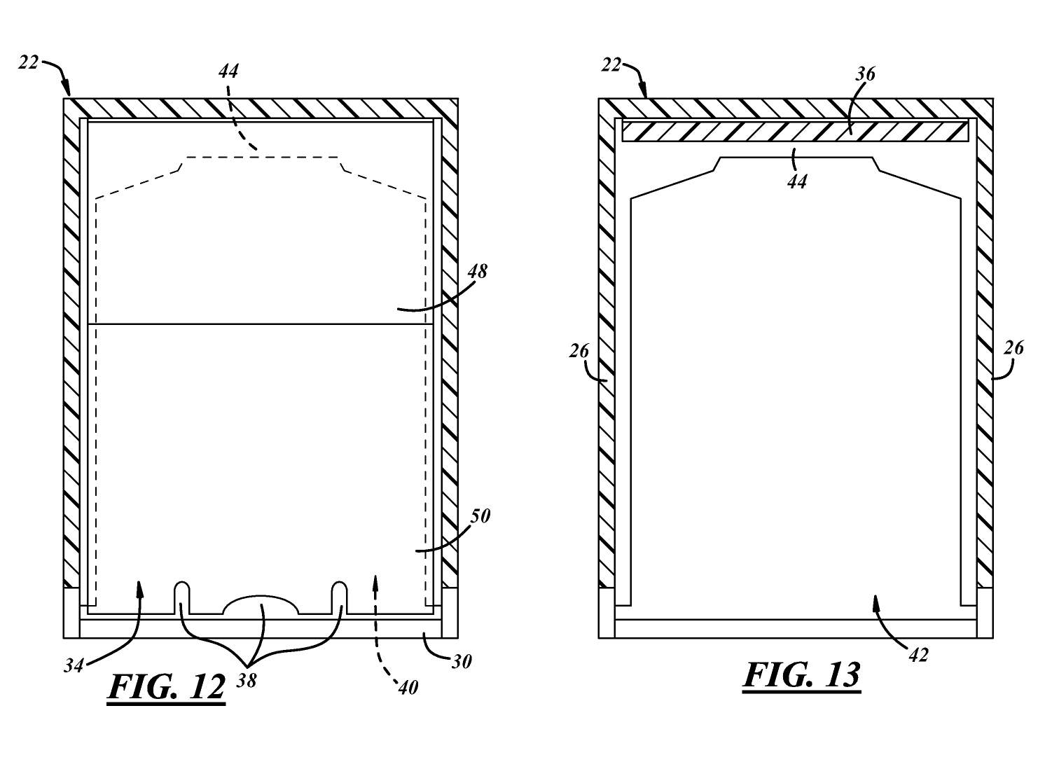

FIGS. 12-14 further illustrate the relationship of tray 36 to system interior 42 when in the closed and open positions. Referring to FIG. 12, first segment 48 and second segment 50 rest on lower retention surface 44 when tray 36 is in the closed position. Tray 36 and base 30 almost entirely obscure lower compartment 40, but gaps 38 in tray 36 allow cables to be routed from upper compartment 34 to lower compartment 40. Accordingly, a user of storage system 22 may store electronic devices and other goods in upper compartment 34, route the cables for those devices through gaps 38, and connect those devices to connections at or extending from electrical connection ports 46. Thus users of this embodiment of system 22 can store electronic devices in upper compartment 34 for secure storage and easy access while keeping the majority of the cables connected to the electronic devices in lower compartment 40. System 22 advantageously reduces clutter in upper compartment 34 while still allowing for connectivity of electronic devices in lower compartment 40.

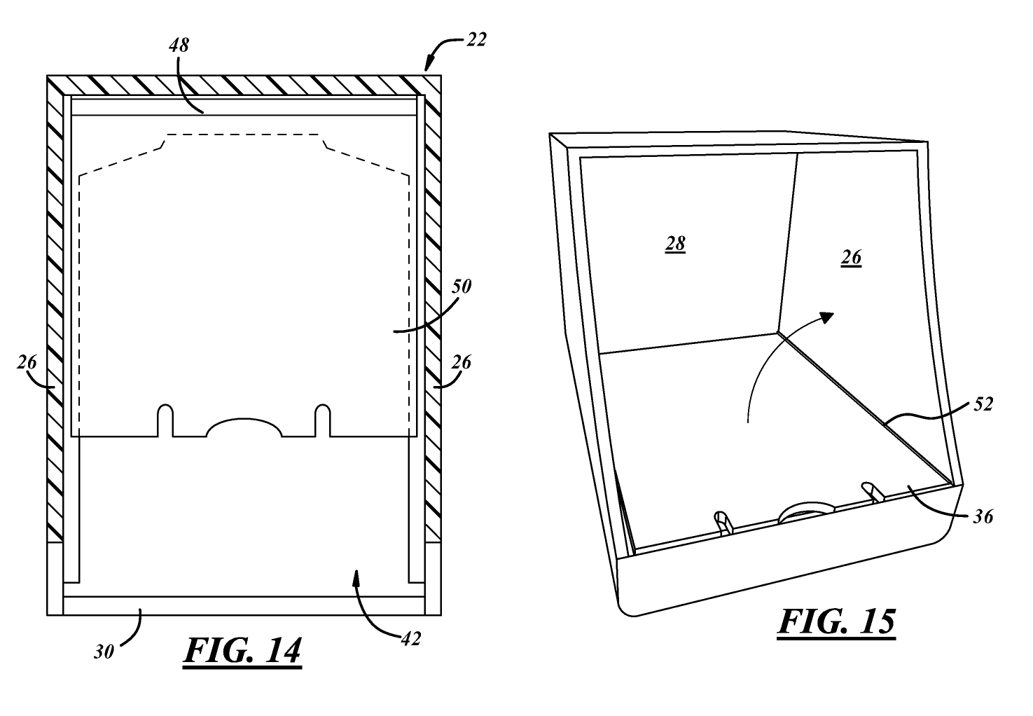

When tray 36 is in the open position, as in FIGS. 13-14, lower compartment 40 is not obscured and system interior 42 may function as a unitary storage compartment. If the user desires, tray 36 may be held in the open position by one or more retention members 56. Retention member 56 may be a latch, a clip, a snap member, a pin, a magnet, an indentation, hinge friction (i.e., a resistance to rotation once rotated to a certain position), or friction between the tray and the sidewalls made possible due to the slight angle between them required for injection molding. In a still further embodiment, the relative dimensions and shapes of side walls 26 and tray 36 are such that tray 36 is held in the open position by friction between tray 36 and side walls 26. Because of retention members 56, system 22 advantageously allows a passenger to leave tray 36 in the open position without worrying that tray 36 could become detached from system 22.

In one embodiment of the invention, storage system 22 is disposed within glove box 12. In this embodiment, access opening 32 faces the door of glove box 12, thereby facing vehicle interior 10 when the glove box door is open, so that system interior 42 is accessible to vehicle interior 10 when the door of glove box 12 is open. In this embodiment, tray 36 may be pivotally connected to end wall 28, to one of side walls 26, or to another surface of system 12. Electrical connection ports 46 may be disposed along the “back” of base 30 within lower compartment 50—the back wall of glove box 12 from the point of view of a passenger in vehicle interior 10. With the door of glove box 12 open, a passenger or driver could move tray 36 to the open position and secure tray 36 with retention members 56 if so desired. In the open position, system interior 42 would be accessible as a unitary storage space to a passenger. Connection ports 46 would be visible and accessible. A passenger may connect cables for one or more electronic devices to ports 46 and move tray 36 to the closed position, routing the cables through gaps 38. Thus the electronic devices can be stored in upper compartment 34 with the cables and connections hidden away in lower compartment 48.

Although a limited number of locations within vehicle interior 10 and a limited number of embodiments of system 22 are described, it should be understood that many variations are possible that fall within the scope of the present invention. Storage system 22 and tray 36 are adaptable to almost any geometry and orientation, so all directional references such as back, front, bottom, and top, are exemplary only and not limiting. Dimensions of system 22, such as size and number of walls and size and number of tray segments, are illustrative only and may be altered within the scope of the invention. References to placement of openings and ports also are exemplary only, as the construction of system 22 or its placement within vehicle interior 10 may alter the desired size, shape, and position of access openings and ports. Furthermore, system 22 may be used for storage of all manner of goods, not just electronic devices. Therefore, all references to storage of electronic goods are exemplary only.

What is claimed is:

1. An automobile storage system comprising:
a base, a pair of opposed side walls and an end wall extending from said base, said base, said side walls and said end wall cooperating to define an access opening configured to allow access to an interior thereof; and
an adjustable divider tray having a first segment and a second segment, said first segment being pivotally connected to one of said end wall and said side walls along a first hinge axis, said first segment being pivotally connected to said second segment along a second hinge axis parallel to said first hinge axis,
said tray having a closed position in which said tray divides said interior into a first compartment and a second compartment wherein said first compartment is accessible via said access opening, and wherein said divider tray is disposed between said access opening and said second compartment,
said tray being movable away from said closed position to an open position in which said interior functions as a unitary compartment.

2. The storage system of claim 1 wherein said divider tray, when in said open position, is generally hidden from a point of view of said access opening.

3. The storage system of claim 1 wherein at least one of said pivotal connections between (i) said first tray segment and said end wall and (ii) said first tray segment and said second tray segment comprise a living hinge.

4. The storage system of claim 1 wherein said pivotal connection between said first and second tray segments comprises a hinge, said hinge being arranged relative to said segments so as to maintain said segments in a substantially co-planar relationship when said tray is in the closed position.

5. The storage system of claim 1 wherein said divider tray is configured for movement between said closed position and said open position, and wherein during said movement said first and second segments are configured to pivot about said first and second hinge axes, respectively.

6. The storage system of claim 1, further comprising a retention member configured to retain said tray in said open position.

7. The storage system of claim 6, wherein said retention member is one of a latch, a clip, a snap member, a pin, a magnet, an indentation and hinge or wall friction.

8. The storage system of claim 1 further comprising a port configured to support an electrical connection wherein said port is located in said second compartment.

9. The storage system of claim 1, wherein said tray includes a gap for routing electrical cables between said first compartment and said second compartment when said tray is in said closed position.

10. The storage system of claim 1, wherein said tray includes a user-graspable gap configured to facilitate manual movement of said tray between said closed position and said open position.

11. The storage system of claim 1, further comprising a retention surface configured to support said tray when in said closed position.

12. The storage system of claim 11, wherein a least a portion of said retention surface is integrated with said base.

13. An automobile storage system comprising:
a plurality of walls defining an interior;
a port for a means for electrical connection; and
a movable tray having an open position and a closed position;
said tray in said closed position configured to substantially divide said interior into a first and a second compartment such that said first compartment is accessible from outside said interior, said second compartment is substantially separated from said first compartment, and said port is disposed within said second compartment;
said tray being movable away from said closed position to said open position, in which said interior functions as a unitary compartment.

14. The storage system of claim 13, further comprising a retention member configured to retain said tray when in said open position.

15. The storage system of claim 13, wherein said tray includes a gap configured for routing cables between said first compartment and said second compartment when said tray is in said closed position.
